(19) United States
(12) Patent Application Publication
(10) Pub. No.: US 2005/0011321 A1
(43) Pub. Date: Jan. 20, 2005

(54) Pliers assembly

(76) Inventor: Chih-Ching Hsien, Taichung (TW)

Correspondence Address: Chih-Ching Hsien, 58, MA YUAN WEST ST., TAICHUNG, TW

(21) Appl. No.: 10/623,313

(22) Filed: Jul. 17, 2003

(51) Int. Cl. B25B 7/02

(52) U.S. Cl. 81/417

(57) ABSTRACT

A pliers assembly includes a first body, a second body pivotally connected with the first body, and an elastic member urged between the first body and the second body and entirely sealed by the first body and the second body. Thus, the elastic member is entirely received in the pliers assembly without being exposed outward, thereby preventing the elastic member from springing outward from the pliers assembly when the elastic member is broken, so as to protect the user's safety.

### BACKGROUND OF THE INVENTION

1. Field of the Invention

The present invention relates to a pliers assembly, and more particularly to a pliers assembly having an elastic member which is received in the pliers assembly without being exposed outward, thereby preventing the elastic member from springing outward from the pliers assembly when the elastic member is broken, so as to protect the user's safety.

2. Description of the Related Art

A conventional hand tool, such as a pair of pliers or the like, in accordance with the prior art shown in FIG. 9 comprises two half portions 40 pivotally combined with each other by a pivot member 42. Each of the two half portions 40 has a first end formed with a jaw portion 44 and a second end formed with a handle portion 46.

In operation, the user has to initially expand the two half portions 40 outward relative to each other to open the jaw portions 44 of the two half portions 40 and then contract the two half portions 40 inward relative to each other to close the jaw portions 44 of the two half portions 40 so as to clamp a workpiece, thereby greatly causing inconvenience to the user in operation of the conventional hand tool.

### SUMMARY OF THE INVENTION

The primary objective of the present invention is to provide a pliers assembly, wherein the locking recess has a tiny circular shape to receive the urging leg of the elastic member, without breaking the structure of the pliers assembly, thereby enhancing the structural strength of the pliers assembly.

Another objective of the present invention is to provide a pliers assembly, wherein the locking recess is formed in the inner peripheral wall of the pivot hole and is sealed by the pivot pin, thereby preventing the oil or dust from being deposited in the locking recess.

A further objective of the present invention is to provide a pliers assembly, wherein the elastic member is entirely received in the pivot hole without being exposed outward from the first body and the second body, thereby preventing the elastic member from springing outward from the pliers assembly when the elastic member is broken, so as to protect the user's safety.

In accordance with the present invention, there is provided a pliers assembly, comprising:
a first body;
a second body pivotally connected with the first body; and
an elastic member urged between the first body and the second body and entirely sealed by the first body and the second body.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a pliers assembly in accordance with the preferred embodiment of the present invention;

FIG. 2 is a perspective assembly view of the pliers assembly in accordance with the preferred embodiment of the present invention;

FIG. 3 is a perspective assembly view of the pliers assembly in accordance with the preferred embodiment of the present invention;

FIG. 3A is a partially cut-away plan cross-sectional view of the pliers assembly as shown in FIG. 3;

FIG. 4 is a schematic top plan operational view of the pliers assembly as shown in FIG. 2 in use;

FIG. 5 is a schematic top plan operational view of the pliers assembly as shown in FIG. 2 in use;

FIG. 6 is an exploded perspective view of a pliers assembly in accordance with another embodiment of the present invention;

FIG. 7 is a schematic top plan operational view of the pliers assembly as shown in FIG. 6 in use;

FIG. 8 is a schematic top plan operational view of the pliers assembly as shown in FIG. 6 in use; and

FIG. 9 is a top plan view of a pair of conventional pliers in accordance with the prior art.

### DETAILED DESCRIPTION OF THE INVENTION

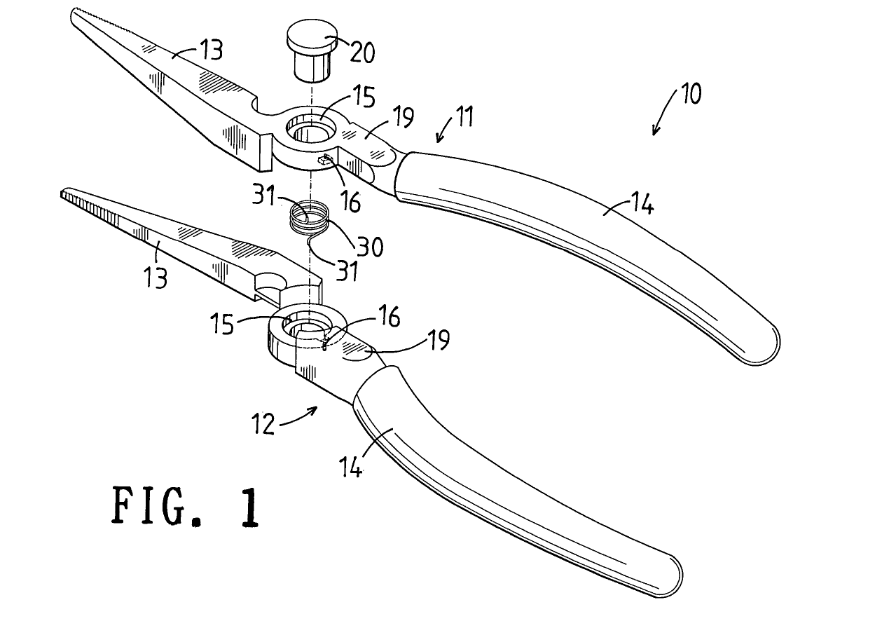

Referring to the drawings and initially to FIGS. 1-5, a pliers assembly 10 in accordance with the preferred embodiment of the present invention comprises a first body 11, and a second body 12 pivotally connected with the first body 11 by a pivot pin 20.

Each of the first body 11 and the second body 12 has a first end formed with a jaw portion 13 and a second end formed with a handle portion 14. Each of the first body 11 and the second body 12 has a mediate section formed with a pivot hole 15 to receive the pivot pin 20. The pivot hole 15 of each of the first body 11 and the second body 12 has an inner peripheral wall formed with a locking recess 16. Preferably, the locking recess 16 of each of the first body 11 and the second body 12 has a circular shape. Each of the first body 11 and the second body 12 is provided with a connecting portion 19 located between the handle portion 14 and the pivot hole 15.

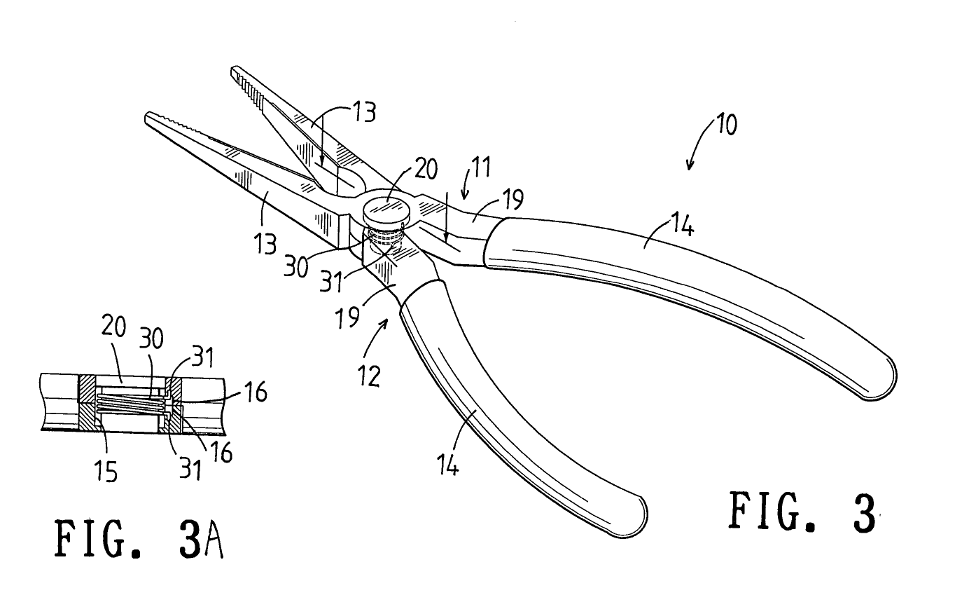

The pliers assembly 10 further comprises an elastic member 30 urged between the first body 11 and the second body 12. Preferably, the elastic member 30 is a torsion spring and is mounted on the pivot pin 20. In addition, the elastic member 30 has two ends formed with two protruding urging legs 31 each locked in the locking recess 16 (see FIG. 3A) of a respective one of the first body 11 and the second body 12. Preferably, the elastic member 30 is entirely received in the pivot hole 15 and sealed by the first body 11 and the second body 12.

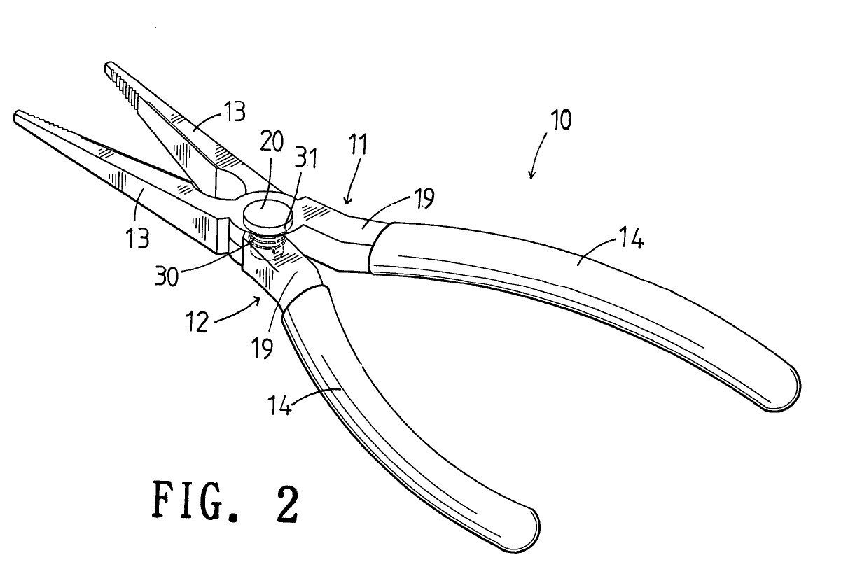

Thus, when not in user, the first body 11 and the second body 12 are expanded outward and spaced away from each other by the urging force of the urging legs 31 of the elastic member 30 as shown in FIG. 2.

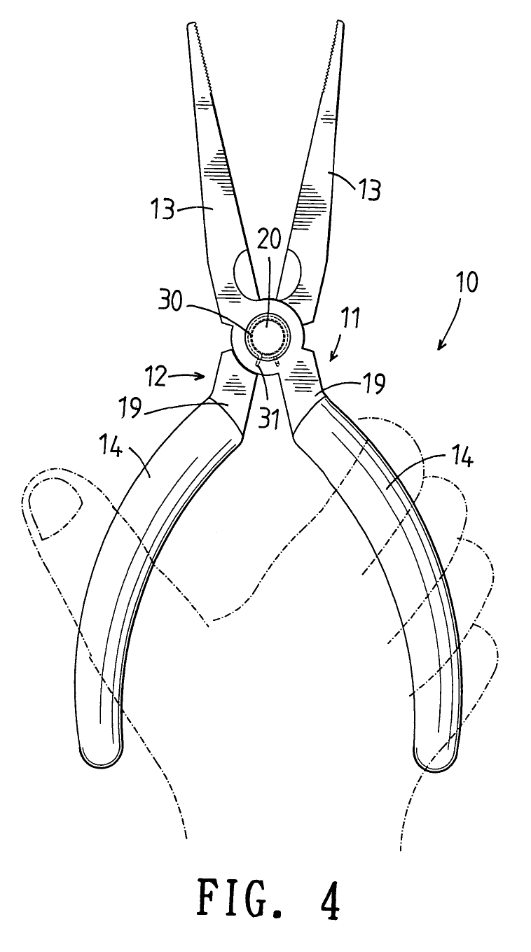

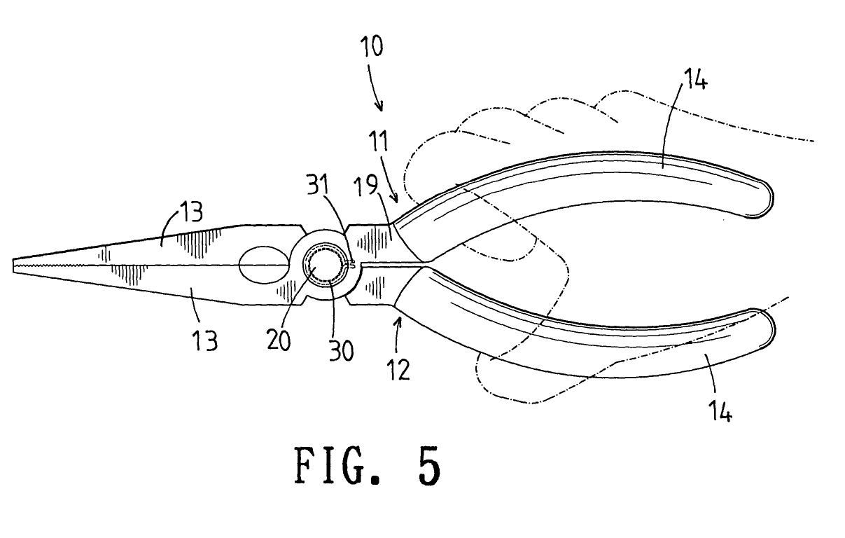

When in use, as shown in FIG. 4, the user's hand exerts a pressing force on the handle portions 14, so that the first body 11 and the second body 12 are contracted inward to abut each other, thereby closing the jaw portions 13 as shown in FIG. 5, so as to clamp a workpiece (not shown). At this time, the elastic member 30 is compressed.

On the contrary, after the pressing force applied on the handle portions 14 is removed, the first body 11 and the second body 12 are expanded outward and spaced away from each other by the restoring force of the elastic member 30 as shown in FIG. 4.

Accordingly, the locking recess 16 of each of the first body 11 and the second body 12 has a tiny circular shape to receive the urging leg 31 of the elastic member 30, without breaking the structure of the pliers assembly 10, thereby enhancing the structural strength of the pliers assembly 10. In addition, the locking recess 16 of each of the first body 11 and the second body 12 is formed in the inner peripheral wall of the pivot hole 15 and is sealed by the pivot pin 20, thereby preventing the oil or dust from being deposited in the locking recess 16. Further, the elastic member 30 is entirely received in the pivot hole 15 without being exposed outward from the first body 11 and the second body 12, thereby preventing the elastic member 30 from springing outward from the pliers assembly 10 when the elastic member 30 is broken, so as to protect the user's safety.

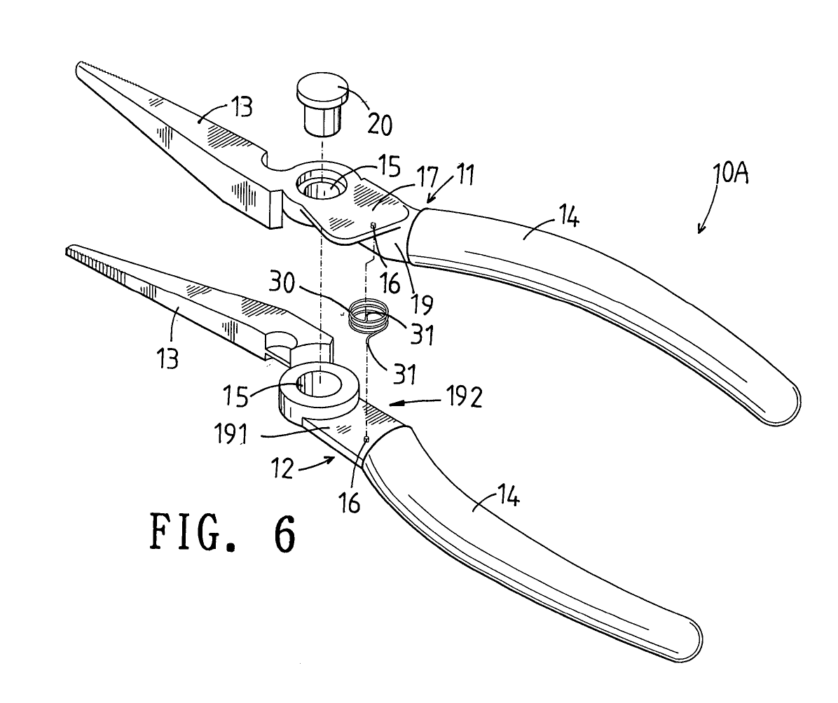

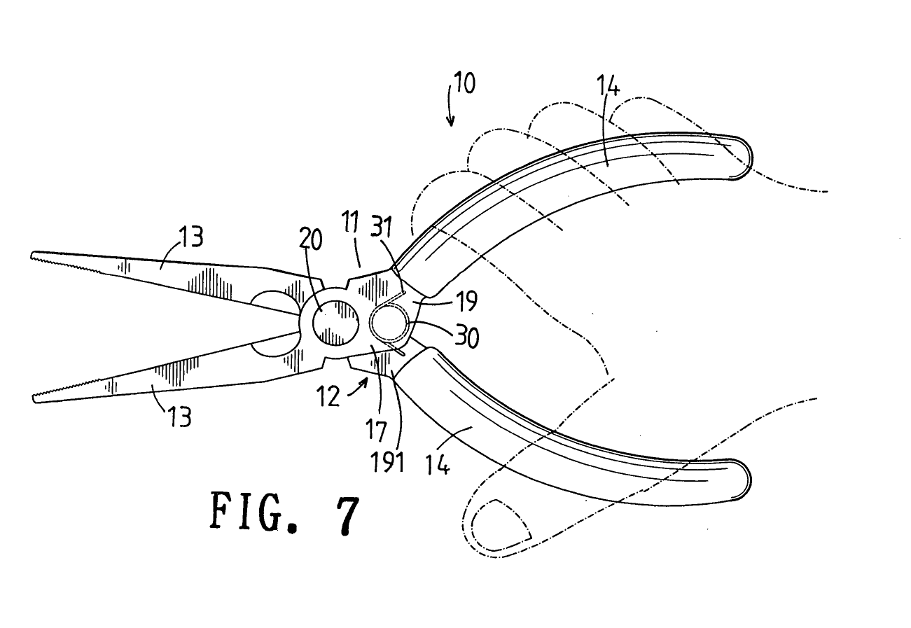

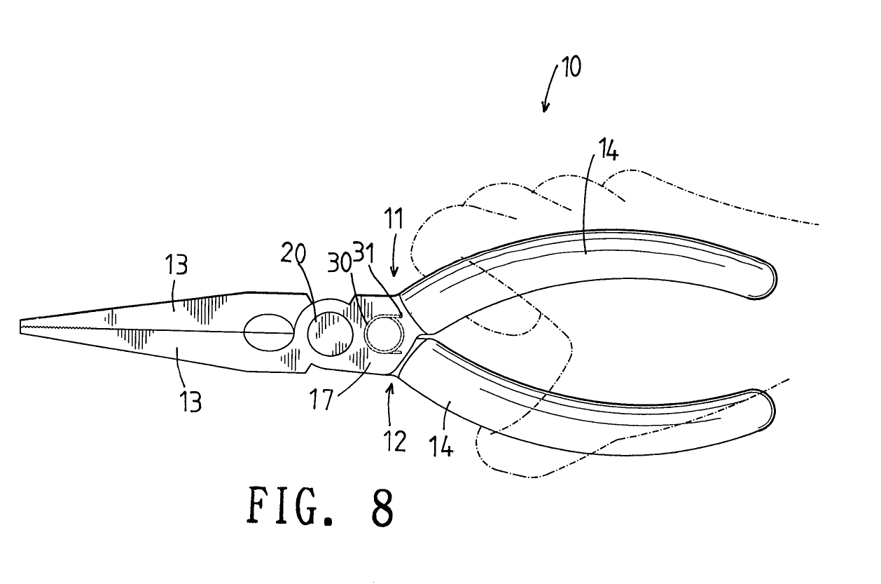

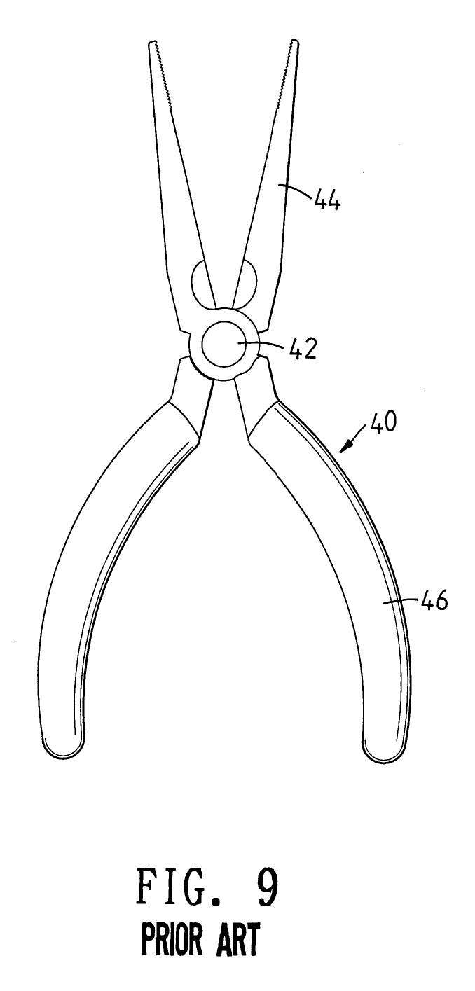

Referring to FIGS. 6-8, a pliers assembly 10A in accordance with another embodiment of the present invention is shown, wherein the first body 11 is provided with a connecting portion 19 located between the handle portion 14 and the pivot hole 15. The connecting portion 19 of the first body 11 is provided with a wing plate 17 extended outward therefrom. In addition, the second body 12 is provided with a connecting portion 191 located between the handle portion 14 and the pivot hole 15. The connecting portion 191 of the second body 12 has a plate shape with a reduced thickness, so that a receiving space 192 is formed between the wing plate 17 of the connecting portion 19 of the first body 11 and the connecting portion 191 of the second body 12 to receive the elastic member 30. In addition, each of the wing plate 17 of the connecting portion 19 of the first body 11 and the connecting portion 191 of the second body 12 is formed with a locking recess 16 to receive and lock the urging legs 31 of the elastic member 30. Thus, the elastic member 30 is located between the wing plate 17 of the connecting portion 19 of the first body 11 and the connecting portion 191 of the second body 12 without being exposed outward from the first body 11 and the second body 12, thereby preventing the elastic member 30 from springing outward from the pliers assembly 10 when the elastic member 30 is broken, so as to protect the user's safety.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A pliers assembly, comprising:
a first body;
a second body pivotally connected with the first body; and
an elastic member urged between the first body and the second body and entirely sealed by the first body and the second body.

2. The pliers assembly in accordance with claim 1, wherein the second body is pivotally connected with the first body by a pivot pin.

3. The pliers assembly in accordance with claim 2, wherein the elastic member is mounted on the pivot pin.

4. The pliers assembly in accordance with claim 1, wherein the elastic member is a torsion spring.

5. The pliers assembly in accordance with claim 2, wherein each of the first body and the second body has a mediate section formed with a pivot hole to receive the pivot pin.

6. The pliers assembly in accordance with claim 5, wherein the pivot hole of each of the first body and the second body has an inner peripheral wall formed with a locking recess, and the elastic member has two ends formed with two protruding urging legs each locked in the locking recess of a respective one of the first body and the second body.

7. The pliers assembly in accordance with claim 6, wherein the locking recess of each of the first body and the second body has a circular shape.

8. The pliers assembly in accordance with claim 5, wherein the elastic member is entirely received in the pivot hole.

9. The pliers assembly in accordance with claim 5, wherein each of the first body and the second body has a first end formed with a jaw portion and a second end formed with a handle portion, and each of the first body and the second body is provided with a connecting portion located between the handle portion and the pivot hole.

10. The pliers assembly in accordance with claim 6, wherein the first body and the second body are expanded outward and spaced away from each other by an urging force of the urging legs of the elastic member.

11. The pliers assembly in accordance with claim 5, wherein the first body has an end formed with a handle portion, the first body is provided with a connecting portion located between the handle portion and the pivot hole, the connecting portion of the first body is provided with a wing plate extended outward therefrom, the second body has an end formed with a handle portion, the second body is provided with a connecting portion located between the handle portion and the pivot hole, a receiving space is formed between the wing plate of the connecting portion of the first body and the connecting portion of the second body to receive the elastic member.

12. The pliers assembly in accordance with claim 11, wherein the connecting portion of the second body has a plate shape with a reduced thickness.

13. The pliers assembly in accordance with claim 11, wherein the elastic member has two ends formed with two protruding urging legs, and each of the wing plate of the connecting portion of the first body and the connecting portion of the second body is formed with a locking recess to receive and lock the urging legs of the elastic member.
